(19) United States
(12) Patent Application Publication
(10) Pub. No.: US 2019/0275827 A1
(43) Pub. Date: Sep. 12, 2019

(54) Compact system to mix and create color materials

(71) Applicants: Harrison Dave Nguyen, Murrieta, CA (US); Juliet Kim, Murrieta, CA (US)

(72) Inventors: Harrison Dave Nguyen, Murrieta, CA (US); Juliet Kim, Murrieta, CA (US)

(21) Appl. No.: 15/918,228

(22) Filed: Mar. 12, 2018

(51) Int. Cl. B43K 5/18; B43K 5/04; B43K 5/14; B43K 8/20; B43K 5/02; A45D 34/04

(52) U.S. Cl. CPC B43K 5/1818; B43K 5/04; B43K 5/14; A45D 2034/007; B43K 5/025; A45D 34/041; A45D 34/042; B43K 8/20

(57) ABSTRACT

A compact system to mix and create color materials is disclosed. The present invention generally related to a color creative system, in which a particular system is capable to create a final mix color of materials from multiple material reservoirs and dispensing the mixed color of material via applicator of choices, all in a single system that can be as small as a pen or a person's thumb or larger as desired. The system is manually operated.

### BACKGROUND OF THE INVENTION

Currently, there isn't such color creative system that allows user to mix color of material in one compact design system.

The present invention generally related to a color creative system, in which a particular system that is capable to create a final mix of color material from multiple material reservoirs and dispensing the mixed color material via applicator of choices, all in a single system that can be as small as a pen or a person's thumb or larger as desired. The system is all manually operated.

### BRIEF DESCRIPTION OF DRAWINGS

A more complete understanding of the present invention may be obtained by referencing to the Detailed Description of The Invention when taken in conjunction with the accompanying Drawings.

FIG. 1 is the front view of the creative color system in accordance with one aspect of the present invention;

FIG. 2 is the rear view of the creative color system in accordance with one aspect of the present invention;

FIG. 3 is the left view of the creative color system in accordance with one aspect of the present invention;

FIG. 4 is the right view of the creative color system in accordance with one aspect of the present invention;

FIG. 5 is the top view of the creative color system in accordance with one aspect of the present invention;

FIG. 6 is the bottom view of the creative color system in accordance with one aspect of the present invention;

FIG. 7 is the detail view of the creative color system in accordance with one aspect of the present invention;

FIG. 8 is the isometric wireframe view of the creative color system in accordance with one aspect of the present invention;

FIG. 9 is the exploded view of the creative color system in accordance with one aspect of the present invention;

FIG. 10 is the access window up view of the creative color system in accordance with one aspect of the present invention;

FIG. 11 is the internal design view of the creative color system in accordance with one aspect of the present invention;

FIG. 12 is the wireframe view of the creative color system in accordance with one aspect of the present invention;

FIG. 13 is the cross section view of the creative color system in accordance with one aspect of the present invention;

FIG. 14 is the example of different applicator types of the creative color system in accordance with one aspect of the present invention;

### DETAILED DESCRIPTION OF THE INVENTION

As stated above, currently there isn't such color creative system that allows user to mix colors of materials in one compact design system. The invention claimed here solves this problem.

The claimed invention differs from what currently exists. To create mix colors of materials, one has to dispense individual material supply of different color in a separate container and mix them up. These result in many steps and require many parts to create a mixed color of material of choice. As such, there is a need for a compact creative color system that can create a mixed color of material without all the hassle.

Accordingly, there is a need for an improved, color creative system that allows user to create a mixed color of materials in a compact design form.

The present invention generally related to a color creative system, in which a particular system that is capable to create a final mix color of materials from multiple material reservoirs and dispensing the mixed color material via applicator of choices, all in a single system that can be as small as a pen or a person's thumb or larger as desired. The system is manually operated.

Also, the creative color system can be used in art application to create painting, sketches, and drawings. The creative color system can be used in cosmetic application in coloring and coating purposes. The creative color system can be used in general painting applications. It can be used in any other application that requires a compact, all-in-one system to create, mix and dispensing color of material without relying on separate color material containers, separate mixing trays or containers.

The Version of the Invention Discussed Here Includes:
1. Body
2. Material Reservoir
3. Access Window
4. Dispensing Lines
5. Mixing Reservoir
6. Applicator
7. Top Cover
8. End Cap

Relationship Between the Components:

Referencing to the figures, the creative color system is shown. The creative color system has a body (1) as shown in FIG. 7, an access window (3) and a top cover (7). The body houses multiple material reservoirs (2), dispensing lines (4), mixing reservoir (5) and applicator assembly (6). An end cap (8) is at the bottom of the body to cover and to protect the applicator.

The material reservoir is made with soft material that enable user to see the color of material in it. The access window is made with transparent material to enable user to see the material reservoir in operation. The mixing reservoir and applicator assembly are also made with transparent material to enable user to see the color of the mixed material before applying.

How the Invention Works:

In operation, the creative color system can be installed with the desired color material reservoirs. Slide up the access window and squeeze the reservoir soft body to dispense the material into the mixing reservoir through the dispensing lines. The amount of dispensing material is manually control by the squeezing pressure and time by user. User can individually create his own mix color of materials for application. To access the material reservoir during operation, slide the access window upward and lock in place. Pull the access window down to cover the material reservoirs. The top cover can be removed to access the material reservoirs compartment.

The material reservoirs can be removed and replaced with the material color of choice even during operation (see FIG. 9). The material reservoir is made with soft material that allows ease of dispensing the material content by slightly squeeze the reservoir body through the opened access window. The material runs through dispensing lines to the mixing reservoir at the applicator assembly. Different materials from different reservoirs combined into the mixing reservoir and mixed by manually shaking the system back and forth. The mixing reservoir and applicator assembly can be removed for cleaning or to replace with other type of applicator. The applicators can be roll-on, wedge, brush or other type of available design to suit application.

How to Make the Invention:

There isn't such compact system to mix and create color of materials, or described here as creative color system, in the market that would allow user to create his own color of material from different supply sources and dispensing the final mix via applicator of choices, all inclusive in a single, small and compact system. The creative color system is capable of delivered all these features and requirements.

How to Use the Invention:

The creative color system is an all-in-one color creation apparatus that allows user to choose what color materials to be mixed together and individual color material reservoir can be replaced or exchanged for different color material of choice to achieve the color that one chooses to create. The final mixed color material is uniquely created by user without the use or aid of any other available technology such as electronic sensor or camera, electronically controlled dispensing, etc. It is rather uniquely created by an individual for his or her individual application. The creative color system is unique and enabling user to be creative with his or her own mixed color of materials with a combined of multiple material color reservoirs in one compact system that can be I various size and shapes.

Additionally: The creative color system can be used for painting, other form of art coloring, hobbies, cosmetics, and other applications that required mixing different color of materials in a small and compact design and the final mixed color material can be applied with the built-in applicator of choices.

The creative color system can be used in art application to create paintings, sketches, drawings. The creative color system can be used in cosmetic application in coloring and coating purposes. The creative color system can be used in general painting applications. It can be used in any other application that requires a compact, all-in-one system to mix, create and dispensing color material without relying on separate color material containers, separate mixing trays or containers.

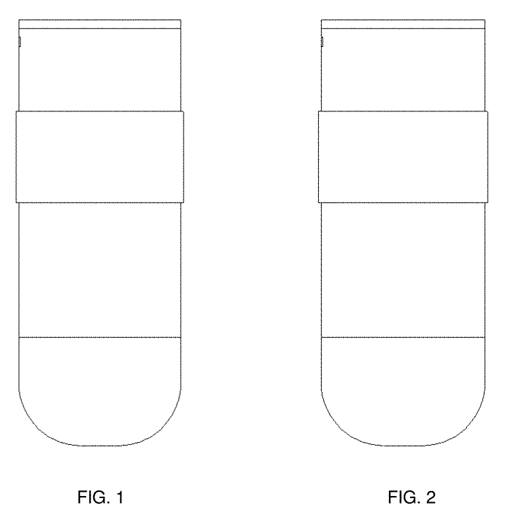

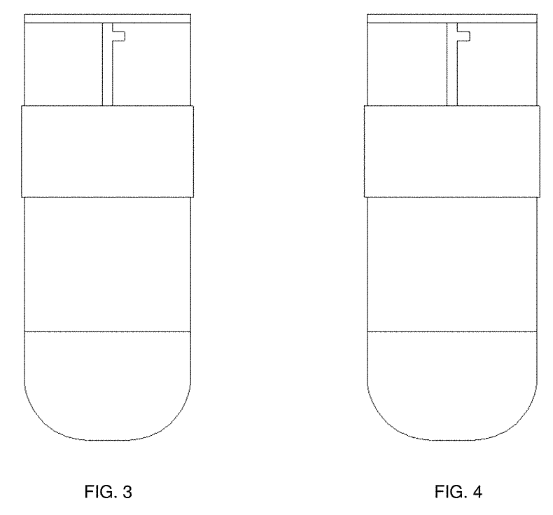

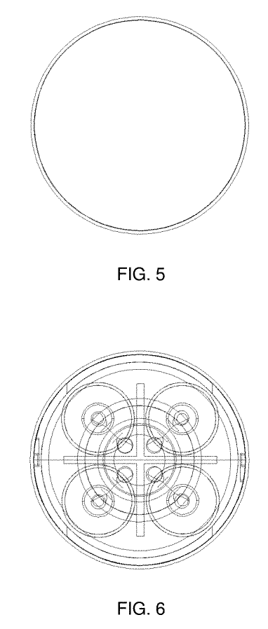

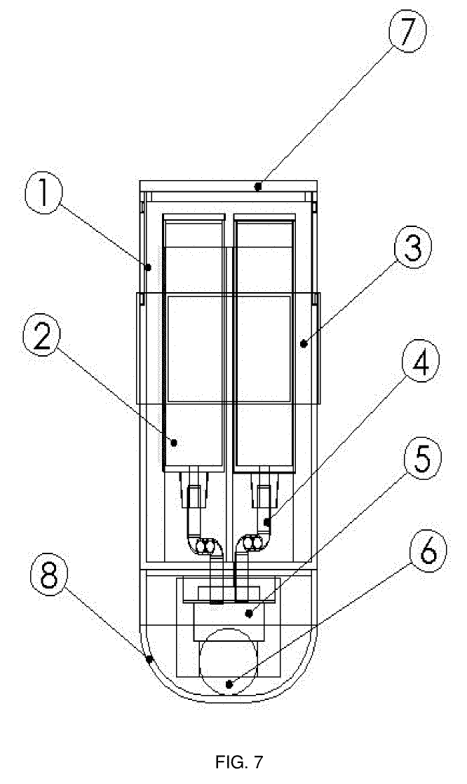

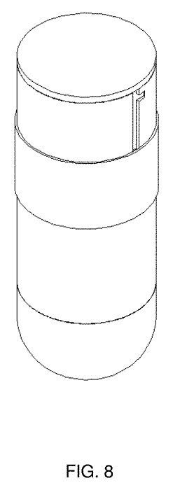

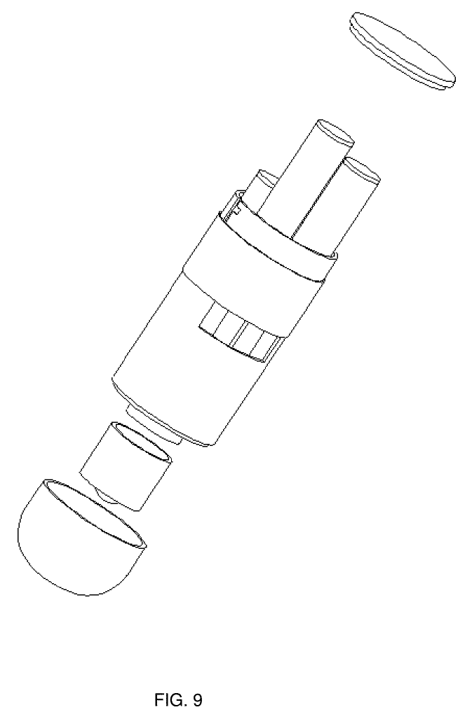

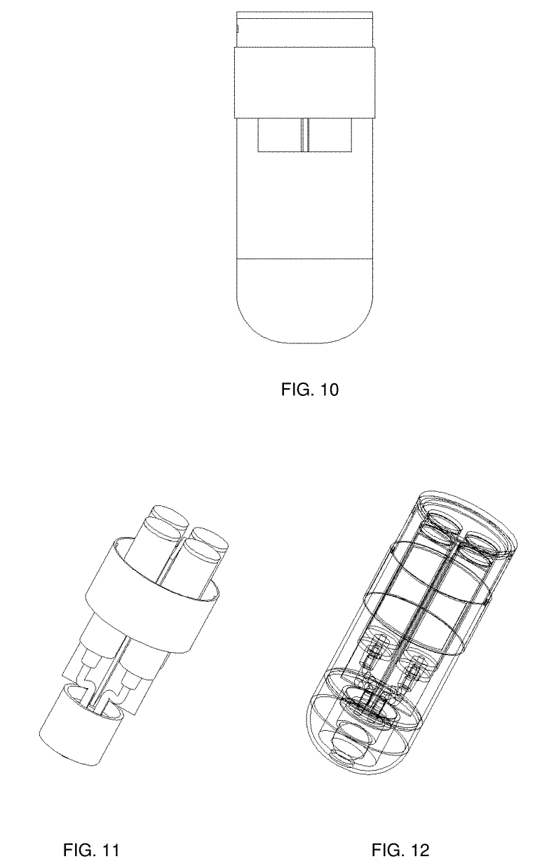

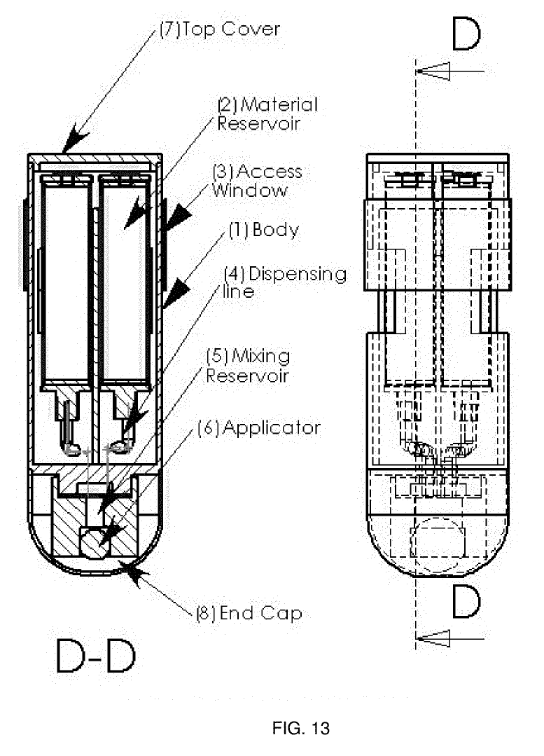

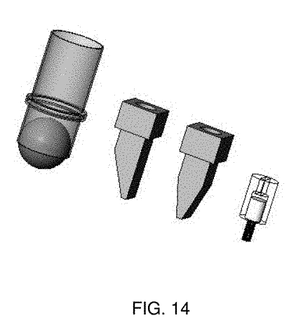

FIG. 1 is the front view of the creative color system. FIG. 2 is the rear view of the creative color system. FIG. 3 is the left view of the creative color system. FIG.4 is the right view of the creative color system. FIG. 5 is the top view of the creative color system. FIG. 6 is the bottom view of the creative color system. FIG. 7 is the detail view of the creative color system. FIG. 8 is the isometric view of the creative color system. FIG. 9 is the exploded view of the creative color system. FIG. 10 is the access window up view of the creative color system. FIG. 11 is the internal design view of the creative color system. FIG. 12 is the wireframe view of the creative color system. FIG. 13 is the cross section view of the creative color system. FIG. 14 is the example of different applicator types of the creative color system.

1. The creative color system comprising:
Body
Material Reservoirs
Access Window
Dispensing Lines
Mixing Reservoir
Applicator
Top Cover
End Cap

2. The creative color system of claim 1, wherein said material reservoir is designed of soft material for manually dispensing the material into the mixing reservoir simply by squeezing its body.

3. The creative color system of claim 2, wherein said multiple material reservoirs can be installed in the system.

4. The creative color system of claim 3, wherein said mixing reservoir is part of the body to receive dispensing materials from reservoirs to be mixed together.

5. The creative color system of claim 4, wherein said material reservoir can be removed, replaced even during operation of the system.

6. The creative color system of claim 5, wherein said mixing reservoir and applicator assembly can be removed for cleaning or replaced with different type of applicator.

7. The creative color system of claim 6, wherein said overall system is unique and enabling user to be creative with his/her own mixed color of material with a combination of multiple material color reservoirs in one compact system that can be in various sizes and shapes.
